(19) United States
(12) Patent Application Publication
(10) Pub. No.: US 2021/0087952 A1
(43) Pub. Date: Mar. 25, 2021

(54) ENGINE SYSTEM

(71) Applicant: BorgWarner Inc., Auburn Hills, MI (US)

(72) Inventor: Young Taek Sun, Gimpo-Si (KR)

(21) Appl. No.: 17/113,529

(22) Filed: Dec. 7, 2020

(51) Int. Cl. F01L 1/348; F01L 1/02

(52) U.S. Cl. CPC F01L 1/348; F01L 1/022

(57) ABSTRACT

An engine system includes a first camshaft, a second camshaft, a first camshaft phaser, and a second camshaft phaser. The first camshaft phaser has a first camshaft sprocket, and the second camshaft phaser has a second camshaft sprocket. The engine system also includes a crankshaft spaced from the first and second camshafts, and a crankshaft sprocket coupled to the crankshaft. The engine system further includes a timing chain coupled to the first and second camshaft sprockets, and the crankshaft sprocket. The timing chain is configured to transmit torque from the crankshaft sprocket to the first and second camshaft sprockets upon rotation of the crankshaft. The engine system further includes a biasing member extending from a first end portion coupled to the first camshaft phaser to a second end portion coupled to the second camshaft phaser to maintain tension on the timing chain between the first and second camshaft phasers.

### BACKGROUND OF THE INVENTION

### 1. Field of the Invention

The invention relates generally to an engine system including first and second camshaft phasers.

### 2. Description of the Related Art

Engine systems known in the art commonly include a first camshaft, a second camshaft, and a crankshaft. The first camshaft typically has a first camshaft sprocket, the second camshaft typically has a second camshaft sprocket, and the crankshaft typically has a crankshaft sprocket. Engine systems known in the art also commonly include a timing chain coupled to the first camshaft sprocket, the second camshaft sprocket, and the crankshaft sprocket to transmit torque from the crankshaft to the first and second camshafts.

The engine systems known in the art further commonly include first and second camshaft phasers. The first and second camshaft phasers advance or retard the phase of the first and second camshafts relative to the crankshaft. However, when the first and second camshaft phasers advancing or retard the phase of the first and second camshafts relative to the crankshaft, the timing chain between the first and second camshaft phasers may fail to remain under tension. As such, the timing chain may experience undue noise, vibration, and harshness near the first and second camshaft phasers.

As such, there remains a need to provide an improved engine assembly.

### SUMMARY OF THE INVENTION AND ADVANTAGES

An engine system includes a first camshaft, a second camshaft spaced from the first camshaft, a first camshaft phaser coupled to the first camshaft, and a second camshaft phaser coupled to the second camshaft. The first camshaft phaser has a first camshaft sprocket disposed about the first camshaft, and the second camshaft phaser has a second camshaft sprocket disposed about the second camshaft.

The engine system also includes a crankshaft spaced from the first and second camshafts, and a crankshaft sprocket coupled to the crankshaft. The engine system further includes a timing chain coupled to the first camshaft sprocket, the second camshaft sprocket, and the crankshaft sprocket. The timing chain is configured to transmit torque from the crankshaft sprocket to the first and second camshaft sprockets upon rotation of the crankshaft.

The engine system further includes a biasing member extending from a first end portion coupled to the first camshaft phaser to a second end portion coupled to the second camshaft phaser to maintain tension on the timing chain between the first and second camshaft phasers. As such, the timing chain is prevented from generating undue noise, vibration, and harshness near the first and second camshaft phasers.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a frontal view of an engine assembly including a first camshaft having a first camshaft sprocket, a second camshaft having a second camshaft sprocket, a crankshaft having a crankshaft sprocket, and a timing chain coupled to the first camshaft sprocket, the second camshaft sprocket, and the crankshaft sprocket;

FIG. 2A is a frontal view of the first and second camshaft phasers, with the engine assembly further including a biasing member having a first end portion coupled to the first camshaft phaser and a second end portion coupled to the second camshaft phasers, with the second end portion of the biasing member proximate to the first camshaft sprocket and the biasing member in a compressed position;

FIG. 2B is a frontal view of the first and second camshaft phasers, with the first end portion of the biasing member distal from the second camshaft sprocket and the biasing member in the extended position;

FIG. 2C is a frontal view of the first and second camshaft phasers, with the second end portion of the biasing member distal from the first camshaft sprocket and the biasing member in the extended position;

FIG. 2D is a frontal view of the first and second camshaft phasers, with the first end portion of the biasing member proximate to the second camshaft sprocket and the biasing member in the compressed position;

FIG. 3A is a frontal view of the biasing member in the extended position, with the first end portion having a first loop defining a first hole through which a first pin may be disposed to couple the first end portion to the first camshaft phaser and with the second end portion having a second loop defining a second hole through which a second pin may be disposed to couple the second end portion to the second camshaft phaser;

FIG. 3B is a frontal view of the biasing member in the free position; and

FIG. 3C is a frontal view of the biasing member in the compressed position.

### DETAILED DESCRIPTION OF THE INVENTION

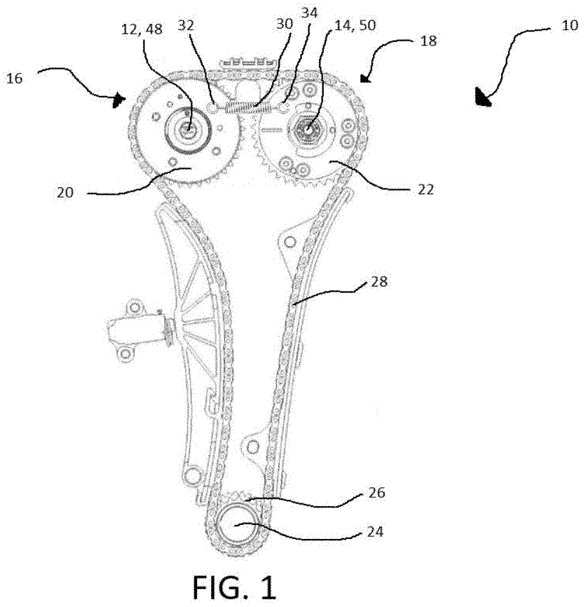

With reference to the Figures, wherein like numerals indicate like parts throughout the several views, an engine system 10 is shown in FIG. 1. The engine system 10 includes a first camshaft 12, a second camshaft 14 spaced from the first camshaft 12, a first camshaft phaser 16 coupled to the first camshaft 12, and a second camshaft phaser 18 coupled to the second camshaft 14. The first camshaft phaser 16 has a first camshaft sprocket 20 disposed about the first camshaft 12, and the second camshaft phaser 18 has a second camshaft sprocket 22 disposed about the second camshaft 14.

The engine system 10 also includes a crankshaft 24 spaced from the first and second camshafts 12, 14, and a crankshaft sprocket 26 coupled to the crankshaft 24. The engine system 10 further includes a timing chain 28 coupled to the first camshaft sprocket 20, the second camshaft sprocket 22, and the crankshaft sprocket 26. The timing chain 28 is configured to transmit torque from the crankshaft sprocket 26 to the first and second camshaft sprockets 20, 22 upon rotation of the crankshaft 24.

The engine system 10 further includes a biasing member 30 extending from a first end portion 32 coupled to the first camshaft phaser 16 to a second end portion 34 coupled to the second camshaft phaser 18 to maintain tension on the timing chain 28 between the first and second camshaft phasers 16, 18. As such, the timing chain 28 is prevented from generating undue noise, vibration, and harshness near the first and second camshaft phasers 16, 18.

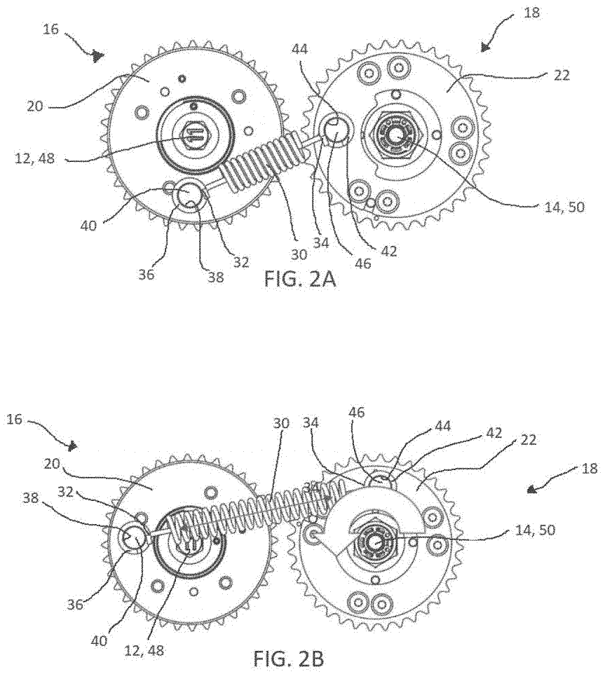

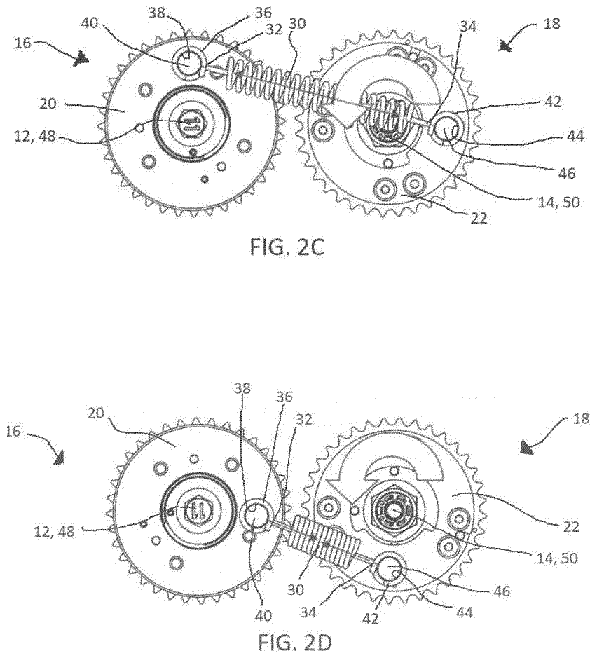

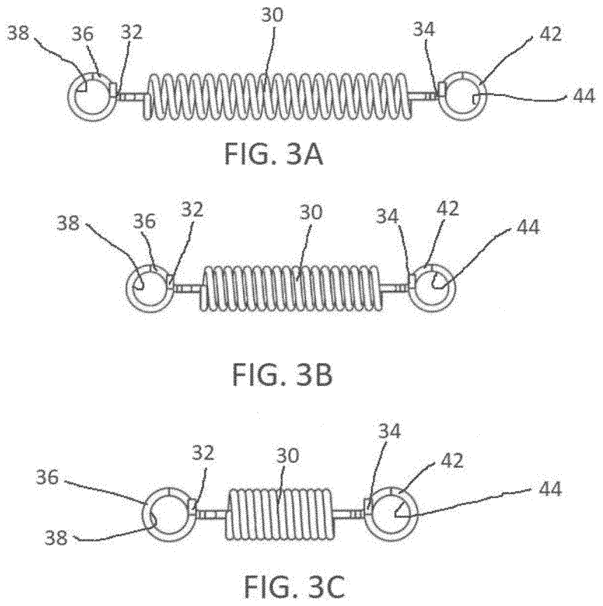

The biasing member 30 may be moveable between an extended position, as shown in FIGS. 2B, 2C and 3A, and a compressed position, as shown in FIGS. 2A, 2D, and 3C. It is also to be appreciated that the biasing member 30 is moveable to a free position, as shown in FIG. 3B, between the extended position and the compressed position. In the extended position, the first and second end portions 32, 34 are spaced a first distance apart from one another. In the compressed position, the first and second end portions 32, 34 are spaced a second distance less than the first distance apart from one another. In other words, the second distance is less than the first distance in the compressed position. It is to be appreciated that the second distance is more than the first distance in the extended position.

The biasing member 30 may be moveable between the extended position and the compressed position based upon rotational positions of the first and second camshaft sprockets 20, 22 of the first and second camshaft phasers 16, 18. As the crankshaft 24 rotates, the timing chain 28 transmits torque from the crankshaft 24, more specifically the crankshaft sprocket 26, to the first and second camshafts 12, 14 through the first and second camshaft sprockets 20, 22. As the first and second camshaft sprockets 20, 22 rotate, the rotational positions of the first and second camshaft sprockets 20, 22 change. In this way, the biasing member 30 may move between the extended position and the compressed position as a result of the first and second camshaft sprockets 20, 22 rotating. More specifically, the biasing member 30 may be configured to alternate between the extended position and the compressed position upon rotation of the first and second camshaft sprockets 20, 22.

The first end portion 32 of the biasing member 30 may be coupled to the first camshaft sprocket 20 of the first camshaft phaser 16. The first end portion 32 of the biasing member 30 may have a first loop 36 defining a first hole 38. Although not required, the first loop 36 may be an English or German hook, and/or may be completely enclosed or at least partially open. The engine system 10 may further include a first pin 40 disposed through the first hole 38 of the first loop 36 to couple the first end portion 32 of the biasing member 30 to the first camshaft sprocket 20 of the first camshaft phaser 16.

The second end portion 34 of the biasing member 30 may be coupled to the second camshaft sprocket 22 of the second camshaft phaser 18. The second end portion 34 of the biasing member 30 may have a second loop 42 defining a second hole 44. Although not required, the second loop 42 may be an English or German hook, and/or may be completely enclosed or at least partially open. The engine system 10 may further include a second pin 46 disposed through the second hole 44 of the second loop 42 to couple the second end portion 34 of the biasing member 30 to the second camshaft sprocket 22 of the second camshaft phaser 18.

The first pin 40 may be disposed through the first hole 38 of the first loop 36 to couple the first end portion 32 of the biasing member 30 to the first camshaft sprocket 20 of the first camshaft phaser 16 at a first angular location on the first camshaft sprocket 20. The second pin 46 may be disposed through the second hole 44 of the second loop 42 to couple the second end portion 34 of the biasing member 30 to the second camshaft sprocket 22 of the second camshaft phaser 18 at a second angular location on the second camshaft sprocket 22.

The first angular location of the first pin 44 and the second angular location of the second pin 46 may be angularly offset relative to one another. It is to be appreciated, however, that the first angular location of the first pin 44 may be the same as the second angular location of the second pin 46. However, in the embodiments where the first angular location of the first pin 44 and the second angular location of the second pin 46 are angularly offset relative to one another, the first angular location and the second angular location may be angularly offset relative to one another by between 180 and 0 degrees, 150 and 30 degrees, and 120 and 60 degrees. It is also be appreciated that the first angular location and the second angular location may be angularly offset relative to one another by approximately 90 degrees.

Although not required, as shown in FIGS. 2A and 2D, the biasing member 30 may be in the compressed position at least when either the first angular location is disposed proximal to the second camshaft sprocket 22 or the second angular location is disposed proximal to the first camshaft sprocket 20. It is to be appreciated that the biasing member 30 may be in the compressed position even when the first angular location is not disposed proximal to the second camshaft sprocket 22 or when the second angular location is not disposed proximal to the first camshaft sprocket 20.

As shown in FIGS. 2B and 2C, the biasing member 30 may be in the extended position at least when either the first angular location is disposed distal to the second camshaft sprocket 22 or the second angular location is disposed distal to the first camshaft sprocket 20. It is to be appreciated that the biasing member 30 may be in the extended position even when the first angular location is not disposed distal to the second camshaft sprocket 22 or when the second angular location is not disposed distal to the first camshaft sprocket 20.

The first camshaft phaser 16 may have a first rotor disposed between the first camshaft sprocket 20 and the first camshaft 12. The second camshaft phaser 18 may have a second rotor disposed between the second camshaft sprocket 22 and the second camshaft 14. The first and second rotors may be used to advance or retard the phases of the first and second camshafts 12, 14 relative to the crankshaft 24.

Although not required, the biasing member 30 may be coil spring. It is to be appreciated, however, that the biasing member 30 may be chosen from a variety of springs including, but not limited to, conical springs, barrel springs, magazine springs, tension springs, and helical springs including compression springs and extension springs.

The first camshaft 12 may be further defined as an intake camshaft 48 configured to operate an intake valve. The intake valve selectively allows intake air to enter into a piston in an internal combustion engine. The second camshaft 14 may be further defined as an exhaust camshaft 50 configured to operate an exhaust valve. The exhaust valve selectively allows exhaust gas to exit from the piston in the internal combustion engine. The exhaust camshaft 50 may have a force exerted on it to rotate counterclockwise even without the biasing member 30 present. This force is referred to as a retard bias on the exhaust camshaft 50.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. An engine system comprising:
a first camshaft;
a second camshaft spaced from said first camshaft;
a first camshaft phaser coupled to said first camshaft, said first camshaft phaser having a first camshaft sprocket disposed about said first camshaft;
a second camshaft phaser coupled to said second camshaft, said second camshaft phaser having a second camshaft sprocket disposed about said second camshaft;
a crankshaft spaced from said first and second camshafts;
a crankshaft sprocket coupled to said crankshaft;
a timing chain coupled to said first camshaft sprocket, said second camshaft sprocket, and said crankshaft sprocket, with said timing chain configured to transmit torque from said crankshaft sprocket to said first and second camshaft sprockets upon rotation of said crankshaft; and
a biasing member extending from a first end portion coupled to said first camshaft phaser to a second end portion coupled to said second camshaft phaser to maintain tension on said timing chain between said first and second camshaft phasers.

2. The engine system as set forth in claim 1, wherein said biasing member is moveable between,
an extended position where said first and second end portions are spaced a first distance apart from one another, and
a compressed position where the first and second end portions are spaced a second distance less than said first distance apart from one another.

3. The engine system as set forth in claim 2, wherein said biasing member is moveable between said extended position and said compressed position based upon rotational positions of said first and second camshaft sprockets of said first and second camshaft phasers.

4. The engine system as set forth in claim 3, wherein said biasing member is configured to alternate between said extended position and said compressed position upon rotation of said first and second camshaft sprockets.

5. The engine system as set forth in claim 1, wherein said first end portion of said biasing member is coupled to said first camshaft sprocket of said first camshaft phaser.

6. The engine system as set forth in claim 5, wherein said first end portion of said biasing member has a first loop defining a first hole.

7. The engine system as set forth in claim 6, further including a first pin disposed through said first hole of said first loop to couple said first end portion of said biasing member to said first camshaft sprocket of said first camshaft phaser.

8. The engine system as set forth in claim 1, wherein said second end portion of said biasing member is coupled to said second camshaft sprocket of said second camshaft phaser.

9. The engine system as set forth in claim 8, wherein said second end portion of said biasing member has a second loop defining a second hole.

10. The engine system as set forth in claim 9, further including a second pin disposed through said second hole of said second loop to couple said second end portion of said biasing member to said second camshaft sprocket of said second camshaft phaser.

11. The engine system as set forth in claim 1, wherein said first end portion of said biasing member has a first loop defining a first hole, and wherein said engine system further includes a first pin disposed through said first hole of said first loop to couple said first end portion of said biasing member to said first camshaft sprocket of said first camshaft phaser at a first angular location on said first camshaft sprocket,
wherein said second end portion of said biasing member has a second loop defining a second hole, and wherein said engine system further includes a second pin disposed through said second hole of said second loop to couple said second end portion of said biasing member to said second camshaft sprocket of said second camshaft phaser at a second angular location on said second camshaft sprocket, and
wherein said first angular location of said first pin and said second angular location of said second pin are angularly offset relative to one another.

12. The engine system as set forth in claim 11, wherein said first angular location and said second angular location are angularly offset relative to one another by between 180 and 0 degrees.

13. The engine system as set forth in claim 12, wherein said first angular location and said second angular location are angularly offset relative to one another by between 120 and 60 degrees.

14. The engine system as set forth in claim 13, wherein said first angular location and said second angular location are angularly offset relative to one another by approximately 90 degrees.

15. The engine system as set forth in claim 11, wherein said biasing member is moveable between,
an extended position where said first and second end portions are spaced a first distance apart from one another, and
a compressed position where the first and second end portions are spaced a second distance less than said first distance apart from one another, and
wherein said biasing member is in said compressed position at least when either said first angular location is disposed proximal to said second camshaft sprocket or said second angular location is disposed proximal to said first camshaft sprocket.

16. The engine system as set forth in claim 11, wherein said biasing member is moveable between,
an extended position where said first and second end portions are spaced a first distance apart from one another, and
a compressed position where the first and second end portions are spaced a second distance less than said first distance apart from one another, and
wherein said biasing member is in said extended position at least when either said first angular location is disposed distal to said second camshaft sprocket or said second angular location is disposed distal to said first camshaft sprocket.

17. The engine system as set forth in claim 1, wherein said first camshaft phaser has a first rotor disposed between said first camshaft sprocket and said first camshaft, and wherein said second camshaft phaser has a second rotor disposed between said second camshaft sprocket and said second camshaft.

18. The engine system as set forth in claim 1, wherein said biasing member is a coil spring.

19. The engine system as set forth in claim 1, wherein said first camshaft is further defined as an intake camshaft configured to operate an intake valve.

20. The engine system as set forth in claim 1, wherein said second camshaft is further defined as an exhaust camshaft configured to operate an exhaust valve.
